(19) United States
(12) Patent Application Publication
(10) Pub. No.: US 2006/0239659 A1
(43) Pub. Date: Oct. 26, 2006

(54) Removable hard disk drive

(76) Inventor: Weng Wah Chng, Singapore (SG)

Correspondence Address: LAWRENCE Y.D. HO & ASSOCIATES PTE LTD, 30 BIDEFORD ROAD, #07-01, THONGSIA BUILDING, SINGAPORE, 229922, SG

(21) Appl. No.: 11/398,523

(22) Filed: Apr. 6, 2006

Related U.S. Application Data
(60) Provisional application No. 60/668,249, filed on Apr. 6, 2005.

(51) Int. Cl. H04N 5/00

(52) U.S. Cl. 386/125

(57) ABSTRACT

The present invention provides a digital video disc (DVD) recorder with a removable hard disk drive (HDD). The DVD recorder has a compartment for accommodating the HDD, wherein the compartment is designed to facilitate the removal of the HDD from the DVD recorder. The compartment provides end-users the convenience of repairing or replacing a faulty HDD. Furthermore, end-users can upgrade the storage capacity of the HDD with ease.

### FIELD OF THE INVENTION

The present invention generally relates to media recorders, and more particularly to a removable hard disk drive for digital video disc (DVD) or digital video broadcast (DVB) recorder.

### BACKGROUND OF THE INVENTION

Multimedia recording and playback devices are becoming increasingly useful and popular for recording video programs and playing those video programs at a later time. For example, the digital video disc (DVD) recorder enables the end-user to record video programs onto a blank DVD. The current DVD recorders have audio-visual (AV) inputs and integrated TV tuner for recording video programs. Furthermore, the DVD recorders can record from other video sources such as digital camcorders.

Generally, DVD recorders provide the end-user with the convenience to pause a live TV program and subsequently continue viewing the program at the moment it was paused. Another advantage is that during the recording of a particular TV program, the end-users are able to start viewing from the beginning of the program without interrupting the recording process. Furthermore, DVD recorders are able to perform simultaneous recording of multiple programs, or simultaneous recording of a program and playing another program.

One type of DVD recorder includes a built-in hard disk drive (HDD). This type of DVD recorder allows the end-user to perform the above-mentioned recording operations either on the HDD or a blank DVD. Typically, one would first record a series of TV programs onto the HDD because it provides a longer recording time than a single blank DVD. Subsequently, the contents in the HDD can be edited and transferred to a blank DVD. Furthermore, the HDD also provides additional recording capacity should a DVD run out of space during recording.

The present DVD recorders such as the PHILIPS DVD Recorders DVDR3360H and DVDR3370H are designed with in-built HDD. Due to the high usage of the HDD, there is high possibility that the HDD will break down before the DVD recorder does. This creates problems. For example, repairing the faulty HDD in the DVD recorder is time-consuming and difficult. Furthermore, the end-user has to send the entire DVD recorder for repair even though recording could still be performed using blank DVDs. It is therefore desirable to provide the end-user with the ability to remove the faulty HDD for repairs or replacement. By bringing the HDD for repairs and replacement would be less burdensome than sending the whole DVD recorder to the repair center. Another benefit is that the end-user can have the option to personally replacing the faulty the HDD or changing the HDD with another higher storage capacity one.

Therefore, there is an imperative need to have a DVD recorder with a removable HDD to allow the end-user to replace or repair the HDD. This invention satisfies this need by disclosing a removable HDD in the DVD recorder. Other advantages of this invention will be apparent with reference to the detailed description.

### SUMMARY OF THE INVENTION

The present invention provides a removable hard disk drive (HDD) for a digital video disc (DVD) or digital video broadcast (DVB) recorder. The removable HDD allows the end-user to replace or repair the HDD. Furthermore, the end-user can change the HDD to a higher storage capacity.

Accordingly, in one aspect, the present invention provides DVD recorder comprising: a housing; a DVD playing/recording module disposed in the housing, wherein the DVD recording module plays media content from DVD and other disc formats and records media content onto a blank DVD and; a compartment disposed in the housing; a hard disk drive (HDD) disposed in the compartment, wherein the HDD records and plays media contents; a controller electrically coupled to the DVD playing/recording module and the HDD, wherein the controller controls the operations of the DVD playing/recording module and the HDD; and wherein the compartment facilitates the removing of the HDD for repair or replacement.

In another aspect, the present invention provides a DVB recorder comprising: a housing; a compartment disposed in the housing; a hard disk drive (HDD) disposed in the compartment, wherein the HDD records and plays media contents;a controller electrically coupled to the HDD, wherein the controller controls the operations of the DVD playing/recording module and the HDD; and wherein the compartment facilitates the removing of the HDD for repair or replacement.

### BRIEF DESCRIPTION OF THE DRAWINGS

Preferred embodiments according to the present invention will now be described with reference to the Figures, in which like reference numerals denote like elements.

FIG. 1 is an illustrative diagram showing a DVD recorder with a removable HDD in accordance with one embodiment of the present invention.

FIG. 2 illustrates an unassembled view of the DVD recorder with a removable HDD in accordance with one alternative embodiment of the present invention.

FIG. 3 is a block diagram illustrating the various components of the DVD recorder.

FIG. 4 is a block diagram illustrating the various components of a DVB recorder.

### DETAILED DESCRIPTION OF THE INVENTION

The present invention may be understood more readily by reference to the following detailed description of certain embodiments of the invention.

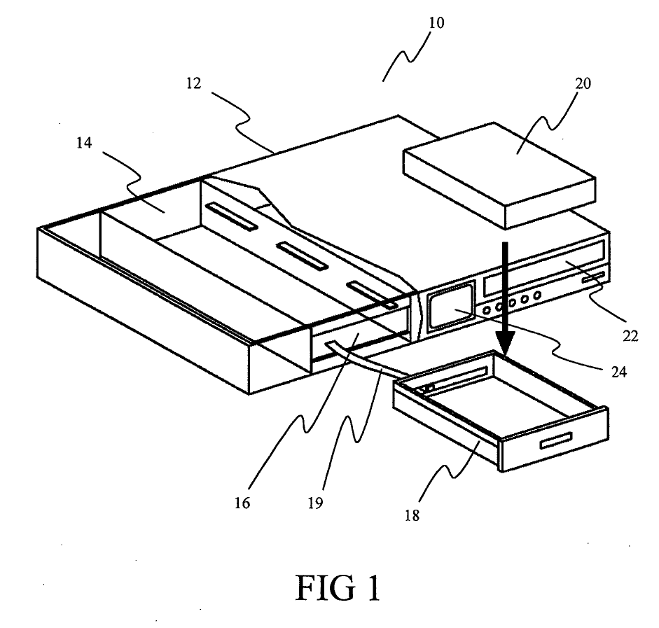

The present invention discloses a digital video disc (DVD) recorder that provides the end-user with the convenience of removing a hard disk drive (HDD) in the DVD recorder for repairs or replacement. Referring to FIG. 1, the DVD recorder 10 comprises a housing 12 that includes a compartment 14 for accommodating the HDD 20, a DVD playing/recording module 22, and a control and display module 24. In a preferred embodiment, the compartment 14 has a slot 16 to receive a drawer 18. The drawer 18 is configured to house the HDD 20, wherein the drawer 18 is slidable along the slot 16 in the compartment 14. The HDD 20 is programmable to play and/or record video from various sources, which will be discussed below.

As shown in FIG. 1, the drawer 18 is capable of being entirely extracted from the slot 16 in the compartment 14 to facilitate the removal of the HDD 20 from the drawer 18. Alternatively, the drawer 18 need not be fully extracted from the slot 16 but is adequately drawn out of the slot 16 to enable the end-user to remove the HDD 20 from the drawer 18 with ease. The slot may comprise locking means to secure the drawer when the drawer is inserted into the housing. It is contemplated that the size of the drawer 18 can be pre-designed to accommodate different sizes of HDD 20 such as 2.5 inch or 3.5 inch sizes. Furthermore, the drawer 18 has a flexible cable 19 to electrically couple the HDD 20 to an internal controller 30, wherein the flexible cable 19 facilitates the sliding motion of the drawer 18 in the slot 16. Preferably, the flexible cable 19 provides an integrated drive electronics (IDE) interface between the HDD 20 and the controller 30. Other forms of electrical connection such as universal serial bus (USB) interface may be used to couple the HDD 20 to the internal controller 30.

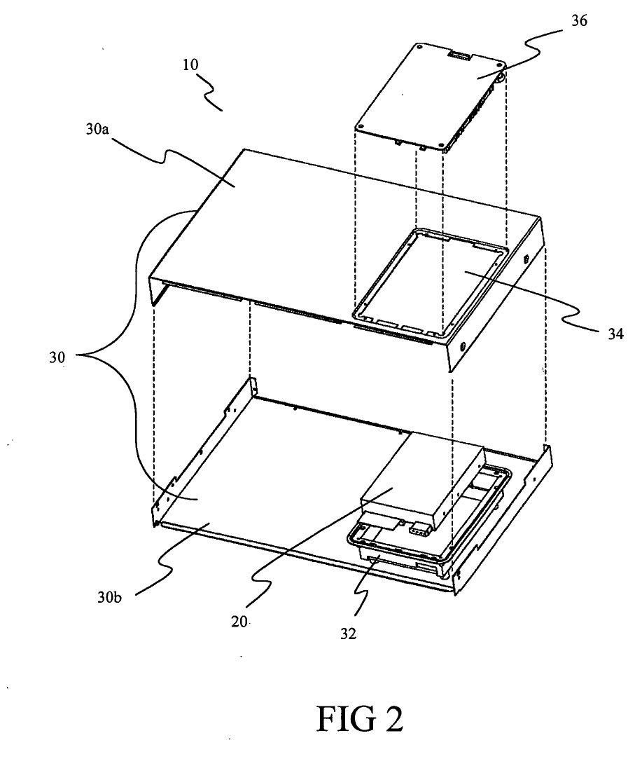

FIG. 2 illustrates an alternative embodiment of the DVD recorder 10 where the HDD 20 is removable from the top of the housing 30. The housing 30 comprises a top section 30a and bottom section 30b to enclose the HDD 20 and other electronic components and circuitry (not shown). In particular, the bottom section has a tray 32 configured to accommodate the HDD 20. The top section has an opening 34 disposed on top of the HDD 20, wherein the opening 34 facilitates the removal of the HDD from the housing 30. The top section 30a further comprises a panel 36 for covering the opening 34, wherein the panel 36 can be detached from top section 30a to allow the HDD 20 to be removed through the opening 34.

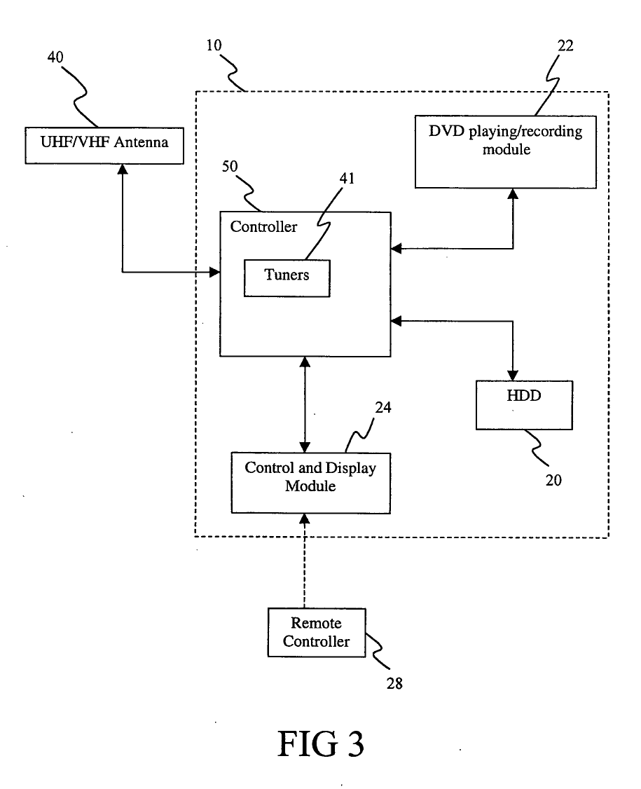

FIG. 3 illustrates a block diagram of the DVD recorder 10. The controller in the DVD recorder 10 may comprise a plurality of tuners 41, wherein the plurality of tuners 41 may be coupled to an external UHF/VHF antenna 40 to enable the DVD recorder 10 to receive video content from various input sources such as cable, satellite or terrestrial broadcast. The controller 50 is electrically coupled to both the HDD 20 and DVD playing/recording module 22, wherein the controller 50 is programmable to record the video content either to the HDD 20 or a blank DVD 22. Both the HDD 20 and DVD playing/recording module 22 can be configured to record different formats such as DVD+R, DVD+RW, DVD-R, DVD-RW. In addition, the DVD playing/recording module 22 is capable of playing a variety of DVD formats, for example DVD+R, DVD-R, DVD+RW, DVD-RW, DVD-ROM, DVD-RAM, DVD-audio, etc. The DVD playing/recording module 22 may also be configured to play other disk formats such as audio compact disc (CD), CD-R, CD-RW, Picture CDs, MP3-CD, WMA-CD, video CD (VCD), etc. It is contemplated that the DVD playing/recording module 22 is not limited to the above disc formats and can be configured to play or record other known or unknown formats. Also, the DVD recording module 22 are not limited to the standard 12 cm diameter size, but can be configured with any other disc diameter size available in the market. The controller 50 is also pre-programmed with the capabilities of identifying a new HDD when the existing HDD 20 becomes faulty and is replaced by the new HDD.

The end-user is able to program or operate the DVD recorder 10 via the control and display module 24. Typically, a remote controller 28 is used by the end-user to communicate with the control and display module 24. The control and display module 24 is electrically coupled to the controller 50 to transfer commands from the remote controller 28 to the controller 50. For example the end-user may select which input source (cable, satellite or broadcast) to view or record. In addition, the DVD recorder 10 may also be configured to receive and play media from other devices such as digital cancorders. An additional I/O port such as audio/video lines or USB ports could be electrically coupled to the controller 30 to transfer the media content from the digital camcorders to the DVD recorder 10. It can be contemplated by one skilled in the art that the I/O port can include other forms of digital data transfer interface such as IEEE 1394 and memory cards transfer. The end-user would have the ability to select either the HDD 20 or DVD playing/recording module 22 to record the video content from the pre-selected input source. Furthermore, DVD recorder 10 allows the end-user to record video contents between the HDD 20 and DVD playing/recording module 22. Also, when the blank DVD runs out of recording space during a particular recording session, the controller 50 will automatically switch the recording to the available storage capacity in the HDD 20.

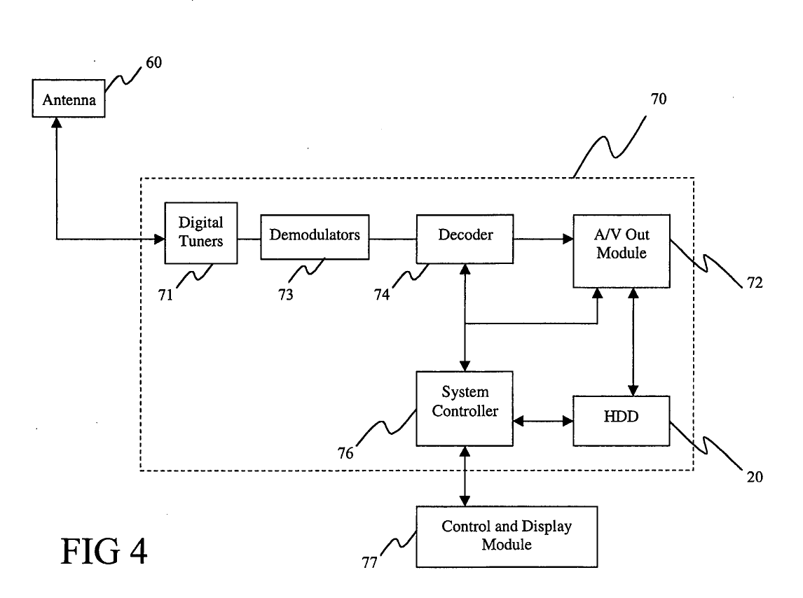

FIG. 4 illustrates a block diagram for a digital video broadcast (DVB) recorder 70 with a removable HDD 20. The DVB recorder 70 has a plurality of digital tuners 71 coupled to an antenna 60 for receiving digital signals from various input sources such as satellite, terrestrial or cable. The plurality of digital tuners 71 allows simultaneous viewing and recording of a video content received from the input source. For example, one of the digital tuners allows the viewing of a TV program while another digital tuner records the TV program. The plurality of tuners 71 is coupled to an audio/video (AN) out module 72 via a plurality of demodulators 73 and a decoder module 74. The digital signal from the plurality of digital tuners 71 is demodulated at the plurality of demodulators 73 and then sent to the decoding module 74. The decoding module 74 then decodes the demodulated digital signal for the A/V out module 72 to be shown on a TV screen. The decoding module 74 can be an MPEG 2 or MPEG 4 decoder. Also, the decoded digital signal can be transferred to the HDD 20 for storage. A system controller 76 is electrically coupled to the decoder module 74, A/V out module 72 and the HDD 20, wherein the system controller 76 controls the data flow of the decoder module 74, AN out module 72 and the HDD 20. Furthermore, the system controller 76 is capable of controlling the multiplexing and demultiplexing operations of the DVB recorder 70. The end-user is able to program or operate the DVB recorder 70 via a control and display module 77. The control and display module 77 is electrically coupled to the system controller 76 and the end-user may use a remote controller to operate the control and display module 77. In addition, a card reader may be coupled to the system controller to allow the end-user to authenticate whether the digital signals received is licensed for the DVB recorder 70.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A digital video disc (DVD) recorder comprising:
a housing;
a DVD playing/recording module disposed in the housing, wherein the DVD recording module plays media content from DVD and other disc formats and records media content onto a blank DVD and;
a compartment disposed in the housing;
a hard disk drive (HDD) disposed in the compartment, wherein the HDD records and plays media contents;
a controller electrically coupled to the DVD playing/recording module and the HDD, wherein the controller controls the operations of the DVD playing/recording module and the HDD; and
wherein the compartment facilitates the removing of the HDD for repair or replacement.

2. The DVD recorder of claim 1, wherein the compartment has a slot to receive a drawer, wherein the drawer is slidable in the slot of the compartment, and wherein the drawer is configured to house the HDD.

3. The DVD recorder of claim 2, wherein the compartment further comprises locking means to secure the drawer when the drawer is inserted into the slot.

4. The DVD recorder of claim 2, wherein the drawer comprises a flexible cable to electrically couple the HDD to the controller.

5. The DVD recorder of claim 4, wherein the flexible cable can be an integrated device electronics (IDE) connector, universal serial bus USB) connector or other forms of connector.

6. The DVD recorder of claim 2, wherein the drawer can be entirely extracted from the compartment.

7. The DVD recorder of claim 2, wherein the drawer is configured to house different sizes of HDD such as 2.5″ HDD or 3.5″ HDD.

8. The DVD recorder of claim 1, wherein the controller has a plurality of tuners electrically coupled to a source that provides media content from cable, satellite or broadcast.

9. The DVD recorder of claim 1 further comprising a remote controller for allowing an end-user to operate the DVD recorder.

10. The DVD recorder of claim 1, wherein the housing has a top panel disposed above the compartment, wherein the top panel can be open to remove the HDD in the compartment.

11. A digital video broadcast (DVB) recorder comprising:
a housing;
a compartment disposed in the housing;
a hard disk drive (HDD) disposed in the compartment, wherein the HDD records and plays media contents;
a controller electrically coupled to the HDD, wherein the controller controls the operations of the DVD playing/recording module and the HDD; and
wherein the compartment facilitates the removing of the HDD for repair or replacement.

12. The DVB recorder of claim 11, wherein the compartment has a slot to receive a drawer, wherein the drawer is slidable in the slot of the compartment, and wherein the drawer is configured to house the HDD.

13. The DVB recorder of claim 12, wherein the compartment further comprises locking means to secure the drawer when the drawer is inserted into the slot.

14. The DVB recorder of claim 12, wherein the drawer comprises a flexible cable to electrically couple the HDD to the controller.

15. The DVB recorder of claim 14, wherein the flexible cable can be an integrated device electronics (IDE) connector, universal serial bus (USB) connector or other forms of connector.

16. The DVB recorder of claim 12, wherein the drawer can be entirely extracted from the compartment.

17. The DVB recorder of claim 12, wherein the drawer is configured to house different sizes of HDD such as 2.5″ HDD or 3.5″ HDD.

18. The DVB recorder of claim 11, wherein the controller has a plurality of tuners electrically coupled to a source that provides media content from cable, satellite or broadcast.

19. The DVB recorder of claim 11 further comprising a remote controller for allowing an end-user to operate the DVB recorder.

20. The DVB recorder of claim 11, wherein the housing has a top panel disposed above the compartment, wherein the top panel can be open to remove the HDD in the compartment.
